(19) United States
(12) Patent Application Publication
(10) Pub. No.: US 2023/0153931 A1
(43) Pub. Date: May 18, 2023

(54) SYSTEM AND METHOD FOR PROPERTY SCORE DETERMINATION

(71) Applicant: Cape Analytics, Inc., Palo Alto, CA (US)

(72) Inventor: Shane Lee, Palo Alto, CA (US)

(21) Appl. No.: 17/989,891

(22) Filed: Nov. 18, 2022

Related U.S. Application Data
(60) Provisional application No. 63/281,017, filed on Nov. 18, 2021.
(60) Provisional application No. 63/318,541, filed on Mar. 10, 2022.

(51) Int. Cl. G06Q 50/16; G06Q 30/02

(52) U.S. Cl. CPC G06Q 50/16; G06Q 30/0206; G06Q 30/0278

(57) ABSTRACT

In variants, the method can include predicting a pre-transaction asset score based on the property attributes for a property, using a model trained on historic transaction information and property attributes for each of a set of training properties.

### CROSS-REFERENCE TO RELATED APPLICATIONS

This application claims the benefit of U.S. Provisional Application No. 63/281,017 filed 18 Nov. 2021 and U.S. Provisional Application No. 63/318,541 filed 10 Mar. 2022, each of which is incorporated in its entirety by this reference.

### TECHNICAL FIELD

This invention relates generally to the real estate field, and more specifically to a new and useful system and method in the real estate property analysis field.

### BACKGROUND

Because each real estate property is unique and because properties are so infrequently transacted, market liquidity for individual properties has historically been difficult to predict (e.g., pre-transaction), because the requisite statistically significant data for comparable properties is simply unavailable. This leads to inaccurate predictions for downstream models, which are currently forced to assume that comparable properties (e.g., sharing similar structural attributes) have comparable liquidity. For example, insurance risk models underestimate resale risk due to this assumption.

Furthermore, even if comparable property transaction information is available, the liquidity of the comparable properties is not necessarily indicative of the liquidity of the property of interest. This is because properties, while comparable based on record attributes (e.g., beds, baths, square footage, construction year, etc.), may differ wildly based on actual condition and/or along other attributes, which can drastically affect the liquidity of the property.

Thus, there is a need in the property field to create a new and useful system and method for property asset scoring.

### BRIEF DESCRIPTION OF THE FIGURES

FIG. 1 is a flowchart representation of the method.

FIG. 2 is an illustrative example of training a model based on the historical score.

FIG. 3 is an illustrative example of determining a predicted score for the test property.

FIG. 4 is an illustrative example of training a model based on the historical score.

FIG. 5 is an illustrative example of determining property attributes.

FIG. 6 is an illustrative example of determining a historical score for the property.

FIG. 7 is an illustrative example of using the predicted score in the real estate appraisal field.

FIG. 8 is an illustrative example of property attribute determination from an image.

FIGS. 9A, 9B, and 9C are illustrative examples of asset score determination based on different types of property information.

FIG. 10 is a schematic representation of a variant of the system.

### DETAILED DESCRIPTION

The following description of the embodiments of the invention is not intended to limit the invention to these embodiments, but rather to enable any person skilled in the art to make and use this invention.

### 1. Overview

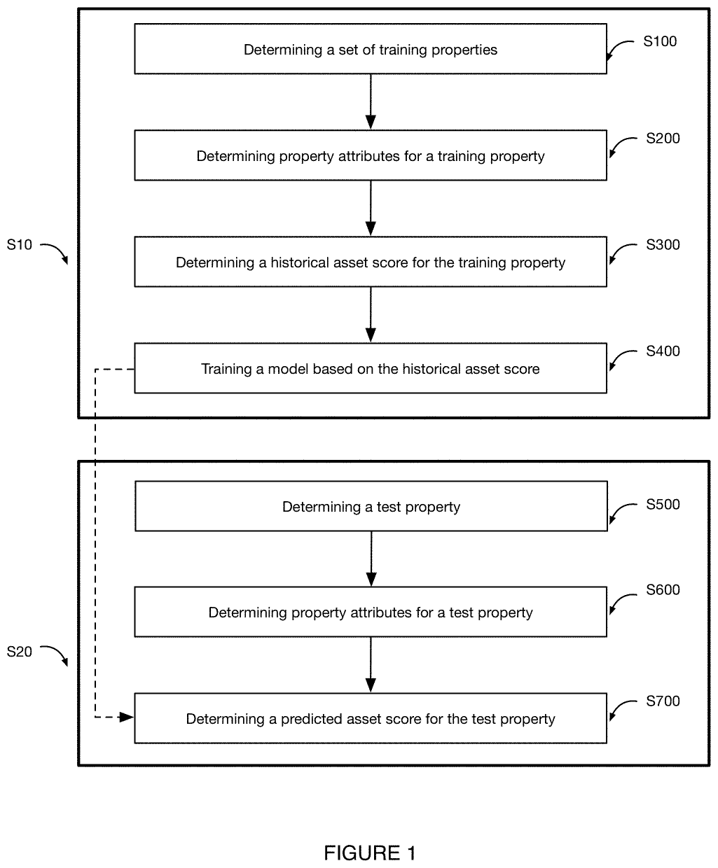

As shown in FIG. 1, variants of the method for property analysis can include: training an asset prediction model S10 and/or predicting an asset score using the trained prediction model S20. Training the prediction model S10 can include: determining a set of training properties S100, determining property attributes for a set of training properties S200, determining a historical score for each training property S300, and training a model based on the historical score S400. Predicting an asset score using the trained prediction model S20 can include: determining a test property S500, determining property information for a test property S600, and determining a predicted asset score for the test property S700. However, the method can additionally and/or alternatively include any other suitable elements.

The method functions to predict an asset score, representative of a pre-transaction probability that a property can be sold easily and quickly without reducing its price, based on property attributes. In variants, the asset score is indicative of real estate market liquidity at the individual property level.

In an illustrative example, the method can include predicting a liquidity score for a test property before it has been transacted. This can include: determining the test property; determining property attributes for the test property (e.g., based on property information, such as property measurements and/or property descriptions); and determining a pre-transaction liquidity score based on the property attribute values for the test property, using a trained asset score model. The asset score model can be trained based on the property attribute values and the historic liquidity score for each of a set of previously-transacted properties, wherein the previously-transacted properties can be comparables (e.g., share property attributes, such as record attributes, condition attributes, location attributes, transaction period attributes, property class, etc.) and/or be otherwise related or unrelated. In an example, the asset score is a liquidity score determined based on the property's days on market (DOM) and sale price (e.g., training property's DOM percentile, sale price percentile, etc.). In a specific example, the asset score for a property can be determined based on the property's DOM percentile and the property's sale price percentile, relative to a reference property population for the property (e.g., training property set). The predicted asset score can optionally be used by downstream models (e.g., automated valuation models, loan models, insurance models, etc.) to predict a secondary market parameter (e.g., property valuation, loan amount, default risk, insurance value, etc.), and/or be used to determine a score-related adjustment (e.g., liquidity adjustment) to the secondary market parameter predicted by the downstream model (e.g., example shown in FIG. 3). In an example, the asset score can be predicted without a sale price or other market information (e.g., be determined solely based on the attributes of the property itself, such as attributes indicative of the property's condition).

### 2. Technical Advantages

Variants of the technology for property analysis can confer several benefits over conventional systems and benefits.

First, variants of the technology can determine retroactive per-property liquidity measures (e.g., for individual properties) based on transaction history (e.g., days on market (DOM), list price, sale price etc.) for the property. For example, in variants, a relative asset score can be determined from dimensionless measures of DOM percentiles and/or price percentiles, which can be useful for retroactive analyses. This provides a taxonomy-free and normalized asset score that is indicative of the liquidity characteristic of the property.

Second, variants of the technology can determine the liquidity for a yet-untransacted property (e.g., before the property transaction). In variants, the technology can determine the liquidity without any transaction information (e.g., historic transaction information, future list price, future sale price, etc.) for the property. In examples, the technology can predict the property of interest's liquidity based on the property's attributes (e.g., condition attributes, such as roof condition, yard condition, quality grade, maintenance condition, etc.), the property's description (e.g., semantic features represented within the property's description, etc.), the property's characteristics, location, location factors, and/or other attributes using a trained model.

Third, variants of the technology can enable a previously manual and subjective process to automatically scale in a normalized, objective manner by automatically extracting the property condition attributes (and/or other attributes) from wide-scale data (e.g., aerial imagery), automatically determining the correct model to use for the property, and automatically determining the liquidity score (e.g., in real- or near-real time, as new information is available for the property). In variants, the liquidity score can be concurrently predicted for multiple properties using a variety of data sources (e.g., wherein the property information can be updated in real or near-real time).

Fourth, real estate markets can be hyper-local, specific to certain property attribute combinations, and/or dynamically evolve over time. Variants of the technology can leverage models that are specific to a location (e.g., zip code, neighborhood, etc.), property attribute combination, and/or timeframe. In variants, the models are periodically retrained (e.g., at the end of a real estate cycle, every June, every predetermined number of days, annually, etc.) to account for temporal fluctuations in real estate market conditions. For example, variants of the technology determine comparable properties for a property given a zip code and a predetermined market time period (e.g., 60 days), and train a model based on the comparable properties, wherein the model is specific to a zip code and a predetermined market time period.

Fifth, the liquidity score can be used to reduce error (e.g., statistical error, variance, etc.) in downstream calculations. In a first example, the liquidity score can be provided as an additional input to a downstream model, such as an AVM model or insurance risk model, wherein inclusion of the liquidity score can reduce the error of the parameter (e.g., secondary market parameter) predicted by the downstream model. In a second example, the liquidity score can be used to determine (e.g., look up, calculate, predict or infer, etc.) a parameter adjustment (e.g., a secondary market parameter adjustment), wherein the parameter determined by the downstream model can be adjusted by the parameter adjustment to decrease the parameter error.

However, further advantages can be provided by the system and/or method disclosed herein.

### 3. System

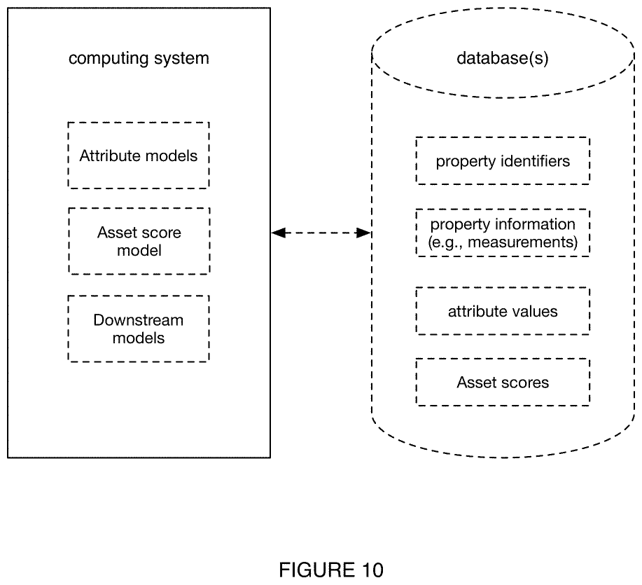

The system can include one or more asset score models, attribute models, downstream models, and/or any other suitable set of components (example system shown in FIG. 10). In variants, the system can determine an asset score (e.g., liquidity score) for one or more properties.

The system can be used with one or more properties. The properties can function as test properties (e.g., properties of interest), training properties (e.g., used to train the model(s)), and/or be otherwise used.

Each property can be or include: a parcel (e.g., land), a property component or set or segment thereof, and/or otherwise defined. For example, the property can include both the underlying land and improvements (e.g., built structures, fixtures, etc.) affixed to the land, only include the underlying land, or only include a subset of the improvements (e.g., only the primary building). Property components can include: built structures (e.g., primary structure, accessory structure, deck, pool, etc.); subcomponents of the built structures (e.g., roof, siding, framing, flooring, living space, bedrooms, bathrooms, garages, foundation, HVAC systems, solar panels, slides, diving board, etc.); permanent improvements (e.g., pavement, statutes, fences, etc.); temporary improvements or objects (e.g., trampoline); vegetation (e.g., tree, flammable vegetation, lawn, etc.); land subregions (e.g., driveway, sidewalk, lawn, backyard, front yard, wildland, etc.); debris; and/or any other suitable component. The property and/or components thereof are preferably physical, but can alternatively be virtual.

Each property can be identified by one or more property identifiers. A property identifier (property ID) can include: geographic coordinates, an address, a parcel identifier, a block/lot identifier, a planning application identifier, a municipal identifier (e.g., determined based on the ZIP, ZIP+4, city, state, etc.), and/or any other identifier. The property identifier can be used to retrieve property information, such as parcel information (e.g., parcel boundary, parcel location, parcel area, etc.), property measurements, property descriptions, and/or other property data. The property identifier can additionally or alternatively be used to identify a property component, such as a primary building or secondary building, and/or be otherwise used.

Each property can be associated with property information. The property information can be static (e.g., remain constant over a threshold period of time) or variable (e.g., vary over time). The property information can be associated with: a time (e.g., a generation time, a valid duration, etc.), a source (e.g., the information source), an accuracy or error, and/or any other suitable metadata. The property information is preferably specific to the property, but can additionally or alternatively be from other properties (e.g., neighboring properties, other properties sharing one or more attributes with the property). Examples of property information can include: measurements, descriptions, attributes, auxiliary data, and/or any other suitable information about the property.

Property measurements preferably measure an aspect about the property, such as a visual appearance, geometry, and/or other aspect. In variants, the property measurements can depict a property (e.g., the property of interest), but can additionally or alternatively depict the surrounding geographic region, adjacent properties, and/or other factors. The measurement can be: 2D, 3D, and/or have any other set of dimensions. Examples of measurements can include: images, surface models (e.g., digital surface models (DSM), digital elevation models (DEM), digital terrain models (DTM), etc.), point clouds (e.g., generated from LIDAR, RADAR, stereoscopic imagery, etc.), depth maps, depth images, virtual models (e.g., geometric models, mesh models), audio, video, radar measurements, ultrasound measurements, and/or any other suitable measurement. Examples of images that can be used include: RGB images, hyperspectral images, multispectral images, black and white images, grayscale images, panchromatic images, IR images, NIR images, UV images, thermal images, and/or images sampled using any other set of wavelengths; images with depth values associated with one or more pixels (e.g., DSM, DEM, etc.); and/or other images.

The measurements can include: remote measurements (e.g., aerial imagery, such as satellite imagery, balloon imagery, drone imagery, etc.), local or on-site measurements (e.g., sampled by a user, streetside measurements, etc.), and/or sampled at any other proximity to the property. The remote measurements can be measurements sampled more than a threshold distance away from the property, such as more than 100 ft, 500 ft, 1,000 ft, any range therein, and/or sampled any other distance away from the property. The measurements can be: top-down measurements (e.g., nadir measurements, panoptic measurements, etc.), side measurements (e.g., elevation views, street measurements, etc.), angled and/or oblique measurements (e.g., at an angle to vertical, orthographic measurements, isometric views, etc.), and/or sampled from any other pose or angle relative to the property. The measurements can depict the property exterior, the property interior, and/or any other view of the property.

The measurements can be a full-frame measurement, a segment of the measurement (e.g., the segment depicting the property, such as that depicting the property's parcel; the segment depicting a geographic region a predetermined distance away from the property; etc.), a merged measurement (e.g., a mosaic of multiple measurements), orthorectified, and/or otherwise processed.

The measurements can be received as part of a user request, retrieved from a database, determined using other data (e.g., segmented from an image, generated from a set of images, etc.), synthetically determined, and/or otherwise determined.

The property information can include property descriptions. The property description can be: a written description (e.g., a text description), an audio description, and/or in any other suitable format. The property description is preferably verbal but can alternatively be nonverbal. Examples of property descriptions can include: listing descriptions (e.g., from a realtor, listing agent, etc.), property disclosures, inspection reports, permit data, appraisal reports, and/or any other text based description of a property.

The property information can include auxiliary data. Examples of auxiliary data can include property descriptions, permit data, insurance loss data, inspection data, appraisal data, broker price opinion data, property valuations, property attribute and/or component data (e.g., values), and/or any other suitable data.

The property information can include property attributes, which function to represent one or more aspects of a given property. The property attributes can be semantic, quantitative, qualitative, and/or otherwise describe the property. Each property can be associated with its own set of property attributes, and/or share property attributes with other properties. As used herein, property attributes can refer to the attribute parameter (e.g., the variable) and/or the attribute value (e.g., value bound to the variable for the property). Property attributes can include: property components, features (e.g., feature vector, mesh, mask, point cloud, pixels, voxels, any other parameter extracted from a measurement), any parameter associated with a property component (e.g., property component characteristics), semantic features (e.g., whether a semantic concept appears within the property information), and/or higher-level summary data extracted from property components and/or features. Property attributes can be determined based on property information for the property itself, neighboring properties, and/or any other set of properties. Property attributes can be automatically determined, manually determined, and/or otherwise determined.

Property attributes can be intrinsic, extrinsic, and/or otherwise related to the property. Intrinsic attributes are preferably inherent to the property's physical aspects, and would have the same values for the property independent of the property's context (e.g., property location, market conditions, etc.), but can be otherwise defined. Examples of intrinsic attributes include: record attributes, structural attributes, condition attributes, and/or other attributes determined from measurements or descriptions about the property itself. Extrinsic attributes can be determined based on other properties or factors (e.g., outside of the property). Examples of extrinsic attributes include: attributes associated with property location, attributes associated with neighboring properties (e.g., proximity to a given property component of a neighboring property), and/or other extrinsic attributes. Examples of attributes associated with the property location can include distance and/or orientation relative to a: highway, coastline, lake, railway track, river, wildland and/or any large fuel load, hazard potential (e.g., for wildfire, wind, fire, hail, flooding, etc.), other desirable site (e.g., park, beach, landmark, etc.), other undesirable site (e.g., cemetery, landfill, wind farm, etc.), zoning information (e.g., residential, commercial, and industrial zones; subzoning; etc.), and/or any other attribute associated with the property location.

Property attributes can include: structural attributes, condition attributes, record attributes, semantic attributes, subjective attributes, and/or any other suitable set of attributes.

Structural attributes can include: structure class/type, parcel area, framing parameters (e.g., material), flooring (e.g., floor type), historical construction information (e.g., year built, year updated/improved/expanded, etc.), area of living space, the presence or absence of a built structure (e.g., deck, pool, ADU, garage, etc.), physical or geometric attributes of the built structure (e.g., structure footprint, roof surface area, number of roof facets, roof slope, pool surface area, building height, number of beds, number of baths, number of stories, etc.), relationships between built structures (e.g., distance between built structures, built structure density, setback distance, count, etc.), presence or absence of an improvement (e.g., solar panel, etc.), ratios or comparisons therebetween, and/or any other structural descriptors.

Condition-related attributes can include: roof condition (e.g., tarp presence, material degradation, rust, missing or peeling material, sealing, natural and/or unnatural discoloration, defects, loose organic matter, ponding, patching, streaking, etc.), wall condition, exterior condition, accessory structure condition, yard debris and/or lot debris (e.g., presence, coverage, ratio of coverage, etc.), lawn condition, pool condition, driveway condition, tree parameters (e.g., overhang information, height, etc.), vegetation parameters (e.g., coverage, density, setback, location within one or more zones relative to the property), presence of vent coverings (e.g., ember-proof vent coverings), structure condition, occlusion (e.g., pool occlusion, roof occlusion, etc.), pavement condition (e.g., percent of paved area that is deteriorated), resource usage (e.g., energy usage, gas usage, etc.), overall property condition, and/or other parameters (e.g., that are variable and/or controllable by a resident). Condition-related attributes can be a rating for a single structure, a minimum rating across multiple structures, a weighted rating across multiple structures, and/or any other individual or aggregate value.

Record attributes can include: number of beds/baths, construction year, square footage, legal class (e.g., residential, mixed-use, commercial, etc.), legal subclass (e.g., single-family vs. multi-family, apartment vs. condominium, etc.), location (e.g., neighborhood, zip code, etc.), location factors (e.g., positive location factors such as distance to a park, distance to school; negative location factors such as distance to sewage treatment plans, distance to industrial zones; etc.), population class (e.g., suburban, urban, rural, etc.), school district, orientation (e.g., side of street, cardinal direction, etc.) and/or any other suitable attributes (e.g., that can be extracted from a property record or listing).

Semantic attributes (e.g., semantic features) can include whether a semantic concept is associated with the property (e.g., whether the semantic concept appears within the property information). Examples of semantic attributes can include: whether a property is in good condition (e.g., “turn key”, “move-in ready”, or related terms appear in the description), “poor condition”, “walkable”, “popular”, small (e.g., “cozy” appears in the description), and/or any other suitable semantic concept. The semantic attributes can be extracted from: the property descriptions, the property measurements, and/or any other suitable property information. The semantic attributes can be extracted using a model (e.g., an NLP model, a CNN, a DNN, etc.) trained to identify keywords, trained to classify or detect whether a semantic concept appears within the property information, and/or otherwise trained.

Subjective attributes can include: curb appeal, viewshed, and/or any other suitable attributes. Other property attributes can include: built structure values (e.g., roof slope, roof rating, roof material, root footprint, covering material, etc.), auxiliary structures (e.g., a pool, a statue, ADU, etc.), risk asset scores (e.g., asset score indicating risk of flooding, hail, wildfire, wind, house fire, etc.), neighboring property values (e.g., distance of neighbor, structure density, structure count, etc.), and/or any other suitable attributes.

Example property attributes can include: structural attributes (e.g., for a primary structure, accessory structure, neighboring structure, etc.), record attributes (e.g., number of bed/bath, construction year, square footage, legal class, legal subclass, geographic location, etc.), condition attributes (e.g., yard condition, roof condition, pool condition, paved surface condition, etc.), semantic attributes (e.g., semantic descriptors), location (e.g., parcel centroid, structure centroid, roof centroid, etc.), property type (e.g., single family, lease, vacant land, multifamily, duplex, etc.), property component parameters (e.g., area, enclosure, presence, structure type, count, material, construction type, area condition, spacing, relative and/or global location, distance to another component or other reference point, density, geometric parameters, condition, complexity, etc.; for pools, porches, decks, patios, fencing, etc.), storage (e.g., presence of a garage, carport, etc.), permanent or semi-permanent improvements (e.g., solar panel presence, count, type, arrangement, and/or other solar panel parameters; HVAC presence, count, footprint, type, location, and/or other parameters; etc.), temporary improvement parameters (e.g., presence, area, location, etc. of trampolines, playsets, etc.), pavement parameters (e.g., paved area, percent illuminated, paved surface condition, etc.), foundation elevation, terrain parameters (e.g., parcel slope, surrounding terrain information, etc.), legal class (e.g., residential, mixed-use, commercial), legal subclass (e.g., single-family vs. multi-family, apartment vs. condominium), geographic location (e.g., neighborhood, zip, etc.), population class (e.g., suburban, urban, rural, etc.), school district, orientation (e.g., side of street, cardinal direction, etc.), subjective attributes (e.g., curb appeal, viewshed, etc.), built structure values (e.g., roof slope, roof rating, roof material, roof footprint, covering material, etc.), auxiliary structures (e.g., a pool, a statue, ADU, etc.), risk scores (e.g., score indicating risk of flooding, hail, fire, wind, wildfire, etc.), neighboring property values (e.g., distance to neighbor, structure density, structure count, etc.), context (e.g., hazard context, geographic context, vegetation context, weather context, terrain context, etc.), historical construction information, historical transaction information (e.g., list price, sale price, spread, transaction frequency, transaction trends, etc.), semantic information, and/or any other attribute that remains substantially static after built structure construction.

In variants, the set of attributes that are used (e.g., by the model(s)) can be selected from a superset of candidate attributes. This can function to: reduce computational time and/or load (e.g., by reducing the number of attributes that need to be extracted and/or processed), increase score prediction accuracy (e.g., by reducing or eliminating confounding attributes), and/or be otherwise used. The set of attributes can be selected: manually, automatically, randomly, recursively, using an attribute selection model, using lift analysis (e.g., based on an attribute's lift), using any explainability and/or interpretability method, based on an attribute's correlation with a given metric or training label, using predictor variable analysis, through predicted outcome validation, during model training (e.g., attributes with weights above a threshold value are selected), using a deep learning model, based on a zone classification, and/or via any other selection method or combination of methods.

Attribute values can be discrete, continuous, binary, multiclass, and/or otherwise structured. The attribute values can be associated with time data (e.g., from the underlying measurement timestamp, value determination timestamp, etc.), a hazard event, an uncertainty parameter, and/or any other suitable metadata.

Attribute values can optionally be associated with an uncertainty parameter. Uncertainty parameters can include variance values, a confidence score, and/or any other uncertainty metric. In a first illustrative example, the attribute value model classifies the roof material for a structure as: shingle with 90% confidence, tile with 7% confidence, metal with 2% confidence, and other with 1% confidence. In a second illustrative example, 10% of the roof is obscured (e.g., by a tree), which can result in a 90% confidence interval for the roof geometry attribute value. In a third illustrative example, the vegetation coverage attribute value is 70%±10%.

The attributes can be determined from property information (e.g., property measurements, property descriptions, etc.), a database or a third party source (e.g., third-party database, MLS™ database, city permitting database, historical weather and/or hazard database, tax assessor database, etc.), be predetermined, be calculated (e.g., from an extracted value and a scaling factor, etc.), and/or be otherwise determined. In a first example, the attributes can be determined by extracting features from property measurements, wherein the attribute values can be determined based on the extracted feature values. In a second example, a trained attribute model can predict the attribute value directly from property information (e.g., based on property imagery, descriptions, etc.). In a third example, the attributes can be determined by extracting features from a property description (e.g., using a sentiment extractor, keyword extractor, etc.). However, the attributes can be otherwise determined. In examples, the attribute values can be determined using the methods disclosed in U.S. application Ser. No. 17/502,825 filed 15 Oct. 2021 and U.S. application Ser. No. 15/253,488 filed 31 Aug. 2016, which are incorporated in their entireties by this reference.

Property attributes and attribute values are preferably determined asynchronously from method execution. Alternatively, property attributes and attribute values can be determined in real time or near real time with respect to the method. Attributes and values can be stored by the processing system performing the determination of property attributes, and/or by any other suitable system. Preferably, storage can be temporary, based on time (e.g., 1 day, 1 month, etc.), based on use (e.g., after one use of the property attribute values by the asset prediction model), based on time and use (e.g., after one week without use of property attribute values), and/or based on any other considerations. Alternatively, property asset data is permanently stored.

However, any other suitable property attribute and/or value thereof can be determined.

The method can be used with one or more models. Each model can be generic or be specific (e.g., to a predetermined set of attributes, geographies, timeframes, etc.). The models can include machine learning models, sets of rules, heuristics, and/or any other suitable model. The machine learning models can include: regression (e.g., logistic regression), neural networks, NLP models, decision trees, random forests, discriminative models (e.g., classifiers), generative models (e.g., Naïve Bayes, etc.), clustering models (e.g., k-nearest neighbors), support vector machines (SVMs), Bayesian networks, dimensional reduction algorithms, boosting algorithms, deep learning systems, classification models, object detectors, an ensemble or cascade thereof, and/or any other suitable model. The classification models can be semantic segmentation models, instance-based segmentation models, and/or any other segmentation model. The classification models can be binary classifiers (e.g., roof vs background, ground vs. non-ground, shadow vs. non-shadow, vegetation vs. non-vegetation, etc.), a multi-class classifier (e.g., multiple labels such as roof, ground, vegetation, shadow, etc.), and/or any other suitable classifier. The model outputs can be discrete, continuous, binary, and/or have any other suitable format. The models can determine (e.g., predict, extract, infer, etc.) one or more: features, attributes, scores, and/or any other output. The models can be trained (e.g., using machine learning methods, such as supervised learning, unsupervised learning, adversarial training, deep learning, tuning, etc.), manually determined, and/or The models can be determined (e.g., newly trained, retrained, etc.): once, periodically, responsive to occurrence of a predetermined event, and/or at any other time.

The models can include one or more: attribute models, asset score models, downstream models, and/or any other suitable model.

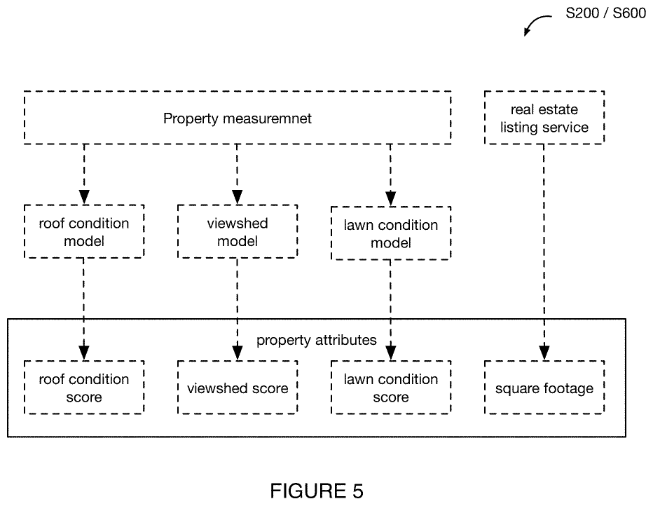

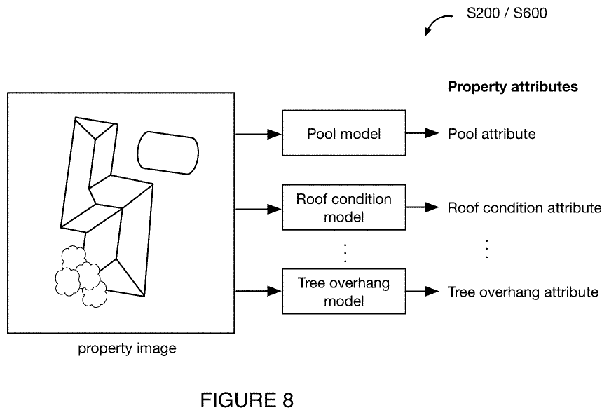

The attribute models function to determine the property attributes for a given property (e.g., examples shown in FIG. 5 and FIG. 8). Each attribute model can determine one or more property attributes (e.g., the values for one or more property attributes); alternatively, each model can determine a single property attribute. Each property attribute is preferably determined by a single model, but can alternatively be determined by multiple attribute models. The attribute models can be globally applicable, be specific to a property attribute (e.g., a geographic region, a timeframe, a property class, etc.), and/or be otherwise specific or generic. The attribute models can optionally determine an error on the property attribute determination (e.g., variance, certainty, probability, etc.). The attribute models can be: neural networks (e.g., CNN, DNN, etc.), regressions, and/or any other suitable model. The attribute models can be trained to determine (e.g., predict) the property attributes based on the property information (e.g., measurements, descriptions, etc.) for each of a set of training properties, or be otherwise determined. Examples of the attribute models that can be used include: condition models (e.g., roof condition, yard condition, etc.), scoring models (e.g., typicality scores, hazard scores, etc.), segmentation models, object detectors, NLP models (e.g., trained to extract sentiment, detect the presence of a concept in a description, etc.), and/or any other attribute model.

The asset score model functions to determine an asset score (e.g., a liquidity score) for one or more properties. The asset score model can additionally or alternatively determine an error (e.g., variance, certainty, probability, etc.) for the asset score.

The asset score model can include a: neural network (e.g., CNN, DNN, etc.), regression, heuristic, equation, and/or any other suitable model. The asset score model can be specific to a timeframe (e.g., a market cycle, a year, a month, 180 days, 90 days, etc.), a geographic region, a set of property attributes (e.g., a set of record attributes), generic, and/or otherwise specific and/or generic. The system can include one or more asset score models (e.g., specific to different timeframes, geographic regions, property attribute sets, etc.). The asset score model can be determined once, periodically determined, determined responsive to occurrence of a predetermined event, dynamically selected (e.g., based on the property's attributes), and/or otherwise determined.

The asset score model can be trained to determine (e.g., predict) the asset score (e.g., liquidity score) based on the property attributes for the property (e.g., the property values for the property), but can additionally or alternatively be trained to predict the asset score based on the property information (e.g., measurements, descriptions, etc.), a hypothetical list price for the property, hypothetical sale price for the property, historic transaction information for the property (e.g., historic DOM, list price, sale price, spread, etc.), historic transaction information for other properties (e.g., sharing property attributes with the property or not sharing property attributes with the property), market attributes (e.g., moving average over predetermined number of days, RSI, etc.), prior property attributes for the property, prior asset scores for the property (e.g., predicted based on prior property attributes, calculated from prior transaction data, etc.), and/or based on any other suitable set of inputs. The asset score can be determined based on the most up-to-date property information that is available, based on property information within a predetermined timeframe (e.g., within the asset model's timeframe, outside of the asset model's timeframe, etc.), and/or based on any other suitable set of property information.

In a first example, the asset score model can predict the asset score for a property based on a set of property attributes for the property (e.g., extracted from property information by a set of attribute models). In a second example, the asset score model can predict the asset score for a property based on a set of property attributes for the property (e.g., extracted from property information by a set of attribute models) and a hypothetical price (e.g., sale price, list price). In a third example, the asset score model can predict the asset score for a property based on a set of property measurements (e.g., aerial imagery, interior imagery, etc.). In a fourth example, the asset score model (e.g., an NLP model) can predict the asset score for a property based on a set of property descriptions (e.g., listing descriptions, appraisal reports, inspection reports, etc.). In a fifth example, the asset score model can predict the asset score for a property based on a set of description features extracted from the property description and a set of other property attributes (e.g., extracted from the property measurements). However, the asset score model can predict the asset score based on any other suitable input.

The asset score can be a measure of liquidity, a probability of property sale, a conversion score (e.g., indicative of the ease or probability of property conversion to another asset class), a measure of how much of a price discount or premium needs to be applied based on the market range, a salability score, a probability of sale given market conditions (e.g., rent and vacancy), a probability that a given property can be sold without adjusting price (e.g., increasing price, reducing price, etc.), a market score, a desirability score (e.g., indicative of how desirable the property is to buyers), a measure of transactability ease, how easily the property will be sold, a transaction score, a marketability score, a salability score, a property conversion score (e.g., indicative of the probability of property conversion to another asset, such as cash), and/or be any other suitable score. The score is preferably dimensionless, but can alternatively have a dimension or set of units (e.g., price, days, etc.). The asset score can be a relative score (e.g., relative to a remainder of a population of properties), be an absolute score (e.g., have semantic meaning independent of other properties), be a category, and/or be otherwise configured. In a first example, the asset score can be a percentile, indicative of how liquid a property is relative to other properties (e.g., a property is in the upper 10^{th} liquidity percentile). In a second example, the asset score can be an absolute score, wherein the score value is indicative of the property's liquidity and/or the adjustment needed to sell the property. In a third example, the asset score can be a category (e.g., a semantic category, such as “very liquid” or “illiquid”; a numeric category; etc.). However, the asset score can be otherwise configured.

In a first variant, the asset score is a relative measure of transactability (e.g., liquidity), wherein the asset score for the properties is determined relative to the attribute values (e.g., sale price, list price) for comparable properties. In these variants, the inventors have discovered that relative market attributes can be more stable measures of liquidity than absolute market attribute values over time, since absolute attributes can be highly susceptible to market conditions. The inventors have further discovered that absolute measures may not correlate as well with inherent property attributes (e.g., property condition, structural attributes, etc.), as relative market attribute values. The relative asset score can be or be determined based on: percentiles, quartiles, standard deviations, variance, ratios thereof, other measures of dispersion, and/or any other relative measure.

In a second variant, the asset score is an absolute market attribute. In a first example, the asset score can be the property's days on market (e.g., difference between list and sale date). In a second example, the asset score can be the property's list price, sale price, and/or spread between the list and sale price. However, any other absolute market attribute can be used.

However, the asset score can be any other suitable score.

The asset score is preferably predicted for a property before the property's transaction (e.g., listing, sale, etc.), but can additionally or alternatively be determined after property transaction and/or at any other time.

The asset score and/or error can be used with or by one or more downstream models (SMP models), which function to determine secondary market parameters for the property. A secondary market parameter can include: valuation, insurance risk, insurance amount, rent, expenses, vacancy, and/or another market parameter. The downstream models can include: neural networks (e.g., CNN, DNN, etc.), regressions, heuristics, equations, and/or any other suitable model. Examples of downstream models can include: automated valuation models (AVM), insurance models, risk model, rental estimate models, expense estimate models, vacancy estimate models, and/or any other suitable secondary market parameter. The downstream models can be trained to predict the actual secondary market parameter for each of a set of training properties, based on the respective property information and/or property attributes, and/or be otherwise trained. The downstream models can be trained based on the same or different set of training properties as that of the asset score model and/or attribute models. The asset score error can be used to determine an uncertainty, error, and/or other property of the secondary market parameter.

In a first variant, the asset score is included in the downstream model input, wherein the downstream model is trained to predict the secondary market parameter based on the asset score for the property (e.g., a single asset score, a timeseries of asset scores, an asset score trend, etc.) and/or related properties.

In a second variant, the asset score is used to determine an adjustment for the secondary market parameter (SMP adjustment) that is predicted by the downstream model. In this variant, the secondary market parameter can be predicted based on or independent of the asset score. The SMP adjustment preferably decreases the prediction error (e.g., the error between the predicted secondary market parameter and the actual secondary market parameter), but can be manually determined or otherwise determined. The SMP adjustment can be: predetermined, dynamically determined, looked up (e.g., from a predetermined set of SMP adjustments for each asset score), calculated based on the asset score, predicted (e.g., based on the asset score, the attribute values, the predicted secondary market parameter), and/or otherwise determined. The SMP adjustment can be specific to: the property attribute set associated with the asset score model that generated the asset score; a geographic region; a timeframe; a specific SMP; a specific SMP provider; and/or otherwise specific or generic.

In a third variant, the asset score can be used to determine an adjustment on another input of the downstream model. The input adjustment preferably decreases the SMP prediction error (e.g., the error between the predicted secondary market parameter and the actual secondary market parameter), but can be manually determined, determined to decrease the input parameter error, or be otherwise determined. The input adjustment can be: predetermined, dynamically determined, looked up (e.g., from a predetermined set of SMP adjustments for each asset score), calculated based on the asset score, predicted (e.g., based on the asset score, the attribute values, the predicted secondary market parameter), and/or otherwise determined.

However, the asset score can be otherwise used.

All or portions of the method can be performed using one or more computing systems. the computing system can be: a remote computing system (e.g., a cloud platform), distributed computing system, local computing system, and/or any other suitable computing system.

The method can optionally be used with one or more external systems. The external systems can function to provide property information (e.g., measurements, descriptions, etc.), determine property attributes (e.g., record attributes), execute models (e.g., the downstream models), and/or perform any other suitable set of functionalities. The system can interact with the external systems via a programmatic interface (e.g., API), and/or otherwise interact with the external systems.

### 3. Method

The method can include: training an asset score prediction model S10 and/or predicting an asset score using the trained prediction model S20. However, the method can be otherwise performed.

All or parts of the method can be performed using the system and/or models discussed above, or be performed using any other suitable system. All or portions of the method can be performed: once, periodically, upon occurrence of a predetermined event, upon receipt of a request from a user, upon receipt of a new property measurement (e.g., depicting multiple properties), upon determination of a new property attribute value, at any other suitable time. One or more instances of the method can be repeated for different properties, different combinations of property attributes, different timeframes, and/or otherwise repeated.

### 3.1 Training an Asset Score Model

Training an asset score model can include: determining a set of training properties S100, determining property information for each training property S200, determining an historical asset score for each training property S300, and training a model based on the historical asset scores and the property information S400. The asset prediction model can be trained: periodically (e.g., semiannually, annually, etc.), when error exceeds a threshold (e.g., when the difference between the predicted asset score and the actual asset score for a given set of properties exceeds a threshold), for each property of interest (e.g., for each queried property in S500), each time a property query is received (e.g., before each S20 instance), and/or at another suitable time. The asset score model is preferably trained automatically, but can alternatively be trained manually or otherwise trained.

Determining a set of training properties S100 functions to determine a training data set. The set of training properties can be determined each time the asset score model is trained, each time a property query is received, and/or at any other time. The training property set can be: automatically determined, manually determined, and/or otherwise determined.

The training property set can be determined based on: market segment (e.g., training properties having a predetermined attribute value set), desired model attributes, a target property (e.g., the target property's attribute values), and/or otherwise determined. Properties within the training property set preferably have similar legal classes, locations, and/or record attribute values (e.g., would be considered comparable properties by appraiser), but can alternatively have different attribute values and/or share other attribute values. Properties within the training property set preferably have different condition attribute values (e.g., a statistically significant distribution of condition attribute values), but can alternatively have similar condition attribute values.

The training properties within the training property set can share one or more property attributes with each other, but can alternatively be related or unrelated. In variants, limiting the training properties within the training property set can reduce statistical noise, increase model accuracy, and/or speed up model training. In a first example, the training properties within the training property set can share one or more record attributes (e.g., similar bed/bath, similar square footage, similar property class, similar list date, similar sale date, etc.). In an illustrative example, the training property set can be limited to single family homes within a predetermined geographic region that were transacted (e.g., sold and/or listed) within a predetermined time period. In a second example, the training properties within the training property set can share one or more condition attributes (e.g., similar roof condition, similar yard condition, similar wall condition, etc.). However, the properties within the training property set can be otherwise related or unrelated.

The common attributes shared between properties within the training property set are preferably also shared with the test property and/or can be inherited by the resultant model. For example, when the training property set includes only single-family homes in a specific geolocation, the resultant model can be specific to single family homes in the specific geolocation, and only be used to predict attribute values for other single-family homes in the specific geolocation. In another example, when the test property is a multi-family home in a specific geolocation, the training property set can include only multi-family homes in the specific geolocation. However, the training property set can be otherwise related to the test property and/or resultant model.

Properties within the training property set are preferably previously transacted (e.g., properties with historic sales information), but can additionally and/or alternatively not be previously transacted (e.g., be associated with synthetic or predicted transaction information). The training property set preferably excludes the test property, but can additionally or alternatively include the test property.

In a first variant, the properties within the training property set were previously transacted within a predetermined timeframe (e.g., wherein the resultant model is associated with the timeframe). The timeframe can be a predetermined duration (e.g., 60 days, 180 days, etc.) from a reference date (e.g., current date, a historical time, etc.), but can alternatively be a predetermined date interval (e.g., from MM-DD-YYYY to MM-DD-YYYY), and/or be any other timeframe. The duration of the timeframe can be: predetermined; selected based on market conditions, market cycles, interest rates, market class (e.g., bull/bear market), and/or otherwise selected; randomly selected; determined based on a current time (e.g., a predetermined duration prior to the current time); and/or otherwise determined. The duration can be constant (e.g., the same across all instances of the method), vary between models, vary between geographic regions, and/or otherwise vary. Properties within the training property set are preferably all listed and sold within the same timeframe, but can alternatively be listed within the same timeframe, sold within the same timeframe, neither listed nor sold within the same timeframe, and/or have any other listing or sale relationship with the timeframe. For example, a training property set can be determined by identifying comparable properties transacted within a timeframe (e.g., listed and sold within the last 60 days), wherein the comparable properties have locations (e.g., same neighborhood, same zip code, same school district, etc.), property class (e.g., residential, commercial building, etc.), and property subclass, (e.g., single family home, multi-family home, industrial zoning, multi-use zoning, office zoning, etc.).

In a second variant, the properties within the training property set share a geographic location (e.g., within the same zip code, within a 10-mile radius, within a distinct proximity to geographic features, etc.).

In a third variant, the properties within the training property set share at least one record attribute or structural attribute (e.g., number of bedrooms, square footage, etc.).

In a fourth variant, the properties within the training property set result from a combination of the previous variants (e.g., properties in a specific zip code and sold in a specific time period with 3 bedrooms and 1 bathroom).

In a fifth variant, all previously transacted properties are included in the training property set.

In a sixth variant, properties in the training property set are comparable properties for a given property (e.g., have similar values for a predetermined set of property attributes, have property attribute values within a predetermined range of the given property's attribute values, etc.). This can include: determining the property attribute values (e.g., legal attributes, record attributes, etc.) for the given property; and identifying comparable properties having the same or similar property attribute values for inclusion in the comparable property set. The given property can be the test property (e.g., property of interest), a training property, a representative property (e.g., identified by the user), and/or any other suitable property. In embodiments, the asset score model can be trained in real time in response to receipt of a property of interest.

However, the training property set can be otherwise determined.

Determining property information for the set of training properties S200 functions to reduce the dimensionality of data representative of the property and/or reduce the amount of noise in the raw property data.

The property information is preferably specific to each training property, but can alternatively be shared across the training property set. The property information can include: property measurements, property descriptions, and/or any other suitable information.

The determined property information is preferably contemporaneous with the training property's transaction information used in S400 (e.g., from a similar time frame, within a predetermined time frame of the transaction information, etc.), but can alternatively be from a different time frame.

Property information can be retrieved, predicted, extracted, and/or otherwise determined. For example, property information can be retrieved from one or more databases, retrieved from an external data source (e.g., real estate listing service, tax assessor, permits, claims, hazard data, public records, etc.), determined using one or more attribute models, a combination thereof, and/or otherwise determined; example shown in FIG. 5.

In a first variant, S200 includes retrieving property measurements for each training property.

In a second variant, S200 includes retrieving property descriptions for each training property.

In a third variant, S200 includes determining a set of property attributes for each training property (e.g., one or more values for each of a set of property attributes). Property attributes can include: property condition attributes, structural attributes, record attributes, subjective attributes, market attributes, semantic attributes (e.g., semantic features), and/or any other suitable attributes.

In a first subvariant, one or more property attributes are inferred or predicted for a property using a model (e.g., classifier, object detector, trained neural network, etc.) based on property information for the training property (example shown in FIG. 8).

In a first embodiment, the property attributes are determined from one or more property measurements. The property measurements are preferably remote imagery (e.g., aerial imagery, satellite imagery, drone imagery), but can alternatively be street-side imagery, property exterior imagery, property interior imagery, a combination thereof, and/or any other imagery, a geometric model of the property (e.g., interior and/or exterior), and/or be any other suitable measurement modality. The imagery can include: one image, multiple images, and/or any other suitable number of images. The imagery can be 2-dimensional, 3-dimensional, and/or have any other suitable dimensionality. For example, a property attribute (e.g., a condition attribute) can be extracted from aerial imagery of the property by a trained model (e.g., a CNN model).

In a second embodiment, the property attributes are determined from one or more property descriptions. The descriptions can be from property listings, appraisal reports, inspection reports, and/or any other suitable description of the property (e.g., text description of the property). For example, a semantic attribute or set thereof (e.g., a vector of semantic features) can be extracted by an NLP model from a property descriptions.

In a first specific example, a debris score for a property can be predicted using a model based on imagery of the property, using a method such as that discussed in U.S. application Ser. No. 17/502,825 filed 15 Oct. 2021, which is incorporated in its entirety by this reference. In a second specific example, a roof condition score can be determined by detecting the roof of a property given an image of the parcel (e.g., using a roof detection model), optionally segmenting the roof from a remainder of the image, and classifying the roof segment with a roof condition score (e.g., using a roof condition model, trained to predict a roof condition using human- or otherwise-labelled training data). In a third specific example, a semantic feature vector for the property can be predicted using a model trained to determine whether a predetermined set of concepts are discussed a description of the property.

In a second subvariant, the property attributes (e.g., square footage, number of beds, number of baths, etc.) can be retrieved from a records database (e.g., MLS, tax assessor database, permit database, etc.), another municipal database, a third party database (e.g., a property data aggregator), and/or any other suitable source.

In a third subvariant, the property attributes can be inferred or predicted based on whether property information of a certain type is available. For example, the lack of interior imagery in an MLS™ listing can be indicative of an illiquid property.

However, property information for the property can be otherwise determined.

Determining a historical asset score for a property S300 functions to determine training target for each training property. The historical asset score is preferably indicative of the liquidity of the training property, but can be any other suitable score.

The historical score is preferably a numerical score (e.g., 100, 500, 2500, continuous, discrete, etc.), but can alternatively be a categorical score. The historical score preferably has a numerical range from 0 to 100, but can alternatively have any other numerical range, a categorical range, and/or any other suitable range. The historical score can be normalized to a predetermined scale, but can alternatively not be normalized.

S300 can include: determining market attributes for each training property within the training property set; and determining the asset score based on the market attribute values for each training property. However, S300 can be otherwise performed.

Determining market attributes for each training property functions to obtain the underlying information that can be used to determine the training property's asset score. The market attributes can be: retrieved (e.g., from a database, a real estate listing service, etc.), calculated, inferred, or otherwise determined. The market attributes are preferably for the same timeframe as the property attributes, but can alternatively be from a different timeframe.

The market attributes for each training property can include: transaction information (e.g., conversion information), geographic region, market state (e.g., bull market, bear market), market interest rates, transaction type (e.g., standard sale, bank-owned or real-estate-owned sale, short sale, etc.), demand metric (e.g., volume of buyers in the market), supply metric (e.g., volume of properties up for sale), and/or any other market attribute. Transaction information can include: a duration (e.g., transaction duration, conversion duration, etc.), such as days on market (DOM); list price; sale price (e.g., actual valuation); spread (e.g., difference between sold price and list price); and/or any other suitable attribute.

Determining the asset score based on the market attribute values for each training property functions to determine the training targets. The asset score can be: calculated, inferred, predicted, and/or otherwise determined.

In a first variant, the asset score is calculated based on the transaction information. In a first example, the asset score is calculated based on the DOM and the sale price. In a second example, the asset score is calculated based on the DOM and the spread. However, the asset score can be otherwise calculated based on the transaction information (e.g., directly based on the transaction information).

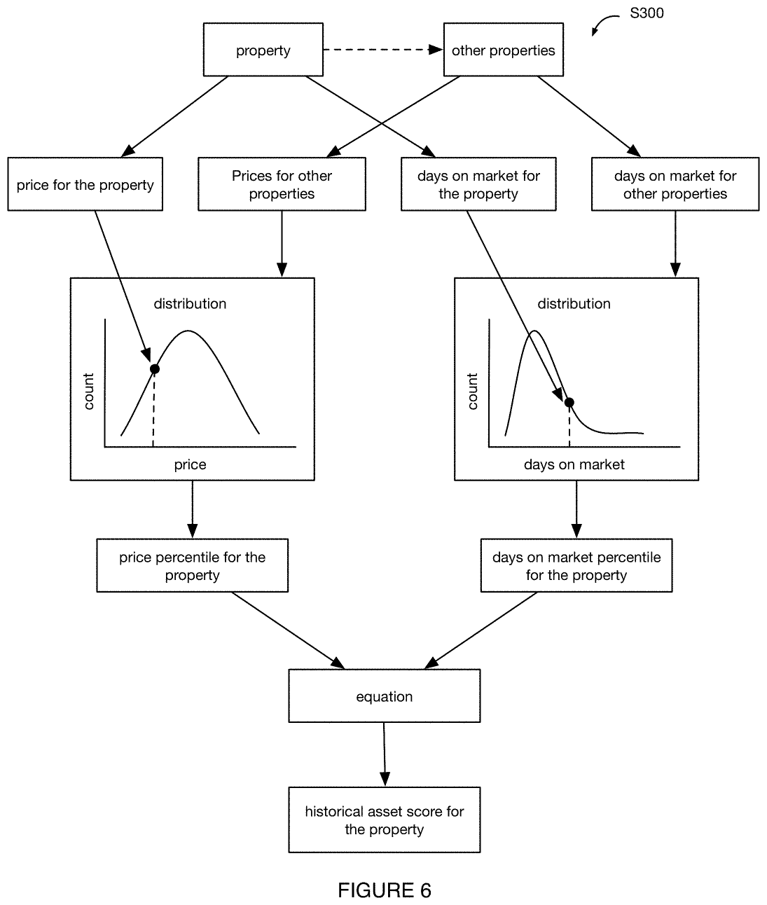

In a second variant, the asset score is determined by: determining the training property's position for a market attribute relative to the training property set, and/or calculating the asset score for the training property based on the market attributes' position. The training property's position can be: a percentile, a statistical distance, and/or any other suitable (computational) position relative to a property population (e.g., the training property set). The training property's market attribute position can be determined by: determining a distribution of the market attribute values across the training property set and determining the training property's market attribute value percentile within the distribution; determining which standard deviation the training property's market attribute value falls within; by dividing the training property's market attribute value by a median market attribute value across the training property set; by clustering the training properties' market attribute values and determining a distance (e.g., cosine distance, etc.) between the training property's market attribute value and a representation of the cluster (e.g., cluster centroid, etc.); and/or otherwise determined. The asset score can be calculated using a weighted sum of the market attribute percentiles (e.g., wherein the weights can be learned, manually assigned, or otherwise determined, etc.), using a predetermined equation, and/or otherwise determined. For example, the equation can include: asset score=0.5*(price_percentile−dom_percentile+100). However, any other suitable equation can be used. In a specific example, the asset score is determined by: determining the property's DOM percentile relative to the other training properties' DOM; determining the property's price percentile relative to the other training properties' prices (e.g., list price, sale price, spread, etc.), and determining the asset score from the property's DOM and price percentiles (e.g., using asset score=0.5*(price_percentile−dom_percentile+100), etc.; for sale prices; for list prices; etc.); example shown in FIG. 6.

In a third variant, the asset score is determined by plotting data points for DOM and price (e.g., sale price, list price, etc.) for the comparable properties against one another (e.g., DOM vs. sale price), and determining a regression line (e.g., based on best-fit) using the data points. If the datapoint associated with the property is above/below the regression line, the property is determined to have a higher/lower asset score, respectively. Additionally or alternatively, the distance between the datapoint associated with the property and the regression line can be a measurement of how high/low the asset score associated to the property is.

In a fourth variant, the asset score is determined by: determining the property's percentile for a set of market attributes relative to the population of comparable properties for the market attributes; and providing the market attribute percentiles to a trained model (e.g., neural network, regression, etc.), wherein the model outputs the asset score and/or classification for the property.

In a fifth variant, the asset score is determined using a model. The model can accept as input transaction variable values (e.g., days on market, sales price, etc.) that can be dimensioned or dimensionless. Optionally, additional variable values can be input into the model (e.g., number of buyers in the market). The model can output a historical score for each property.

In a sixth variant, the asset score is manually determined.

However, the historical asset score can be otherwise determined.

In variants, the S300 can additionally or alternatively include categorizing numeric asset score, wherein the categorized asset score is used to train the asset score model (e.g., the asset score model is trained to predict the category). Categorizing the asset score can include: grouping the asset scores into categories based on the asset score values, classifying the asset score using a model, and/or otherwise categorizing the asset score. In an example, the numeric asset scores for each training property can be aggregated and divided into a predetermined number of categories, wherein the resultant category is used as the asset score for each respective training property. In an illustrative example, an asset score range of 0 to 100 can be evenly or unevenly split into five categories (e.g., category 1: 0-20, category 2: 21-40, category 3: 41-60, category 4: 61-80, category 5: 81-100; etc.), wherein the training property's categorical asset score is the category that its numeric asset score fell into.

However, the historical asset score for the property can be otherwise determined.

Determining an asset score model based on the historical score S400 functions to train a model to predict an asset score for a property.

The asset score model preferably predicts the asset score without transactional information for the property, but can additionally or alternatively include one or more pieces of transactional information (e.g., sale price, list price, historic transaction information for the property and/or neighboring properties, etc.).

The asset score model can be determined once, periodically (e.g., every predetermined number of days, etc.), at random times, upon occurrence of a trigger event (e.g., when the interest rate changes, when the accuracy of the model falls below a predetermined threshold, etc.), and/or any other suitable time.

The asset score model can be specific to a location (e.g., zip code, neighborhood), a predetermined timeframe (e.g., 30 days, 60 days, 120 days, 180 days, etc.), a predetermined time period (e.g., January 2021 to December 2021), a market state (e.g., bull market, bear market, interest rate value, etc.), a property class (e.g., residential, commercial, etc.), a property subclass (e.g., single family, duplex, triplex, apartment, etc.), a set of property attribute values, and/or be otherwise specific. Additionally, and/or alternatively, the model can be generic across locations, timeframes, property classes, property subclasses, property attribute values, and/or be otherwise generic.

The asset score model can include a neural network (e.g., CNN, DNN, etc.), leverage regression, classification, rules, heuristics, equations (e.g., weighted equations), instance-based methods (e.g., nearest neighbor), regularization methods (e.g., ridge regression), decision trees, Bayesian methods (e.g., Naïve Bayes, Markov, etc.), kernel methods, probability, deterministics, support vectors, and/or any other suitable model or methodology. The asset score model is preferably trained, but can alternatively be manually determined, and/or otherwise determined. The asset score model can be trained using deep learning (e.g., Euclidean distance comparison), supervised learning (e.g., backpropagation), unsupervised learning (e.g., stochastic gradient descent), and/or other learning modalities.

The asset score model is preferably determined based on information for the training property set, but can additionally or alternatively be determined based on information for other properties, general market data, and/or any other suitable training data.

The asset score model preferably ingests property attributes of the property, more preferably inherent attributes for the property (e.g., condition attributes, structural attributes, record attributes, etc.), but can additionally and/or alternatively ingest market attributes (e.g., sale price, sale date, other sale data, list price, list date, other listing data, vacancies, supply, demand, etc.), property descriptions (e.g., listing agent comments, appraisal reports, inspection reports, etc.), auxiliary data, a property measurement, and/or any other suitable input. The asset score model preferably outputs an asset score, but additionally and/or alternatively output property attributes, auxiliary data, a property measurement, and/or any other suitable output.

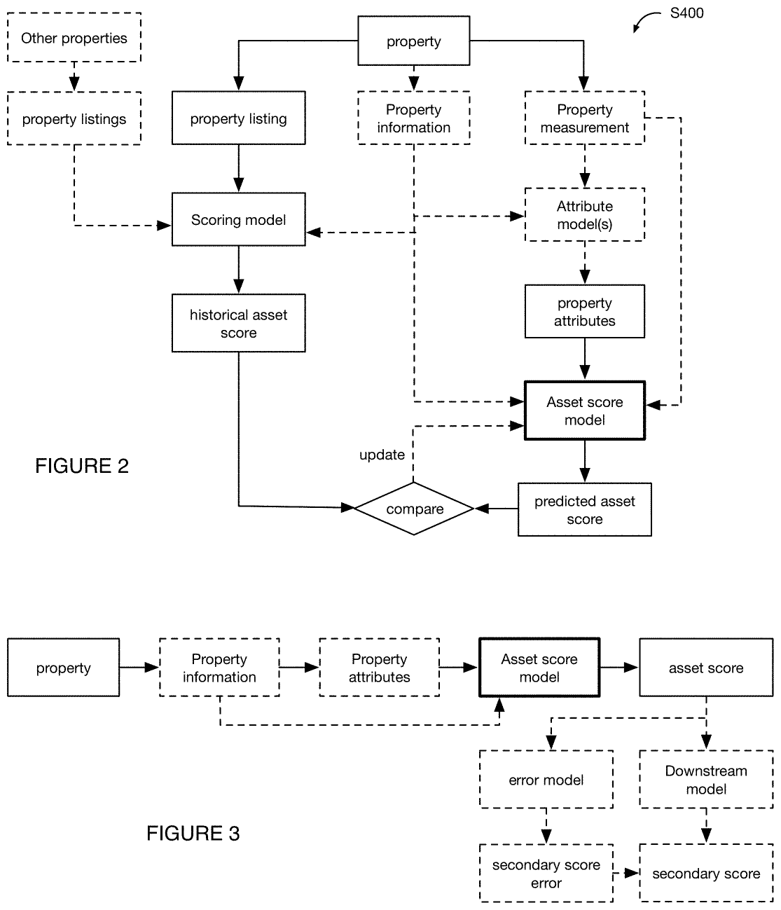

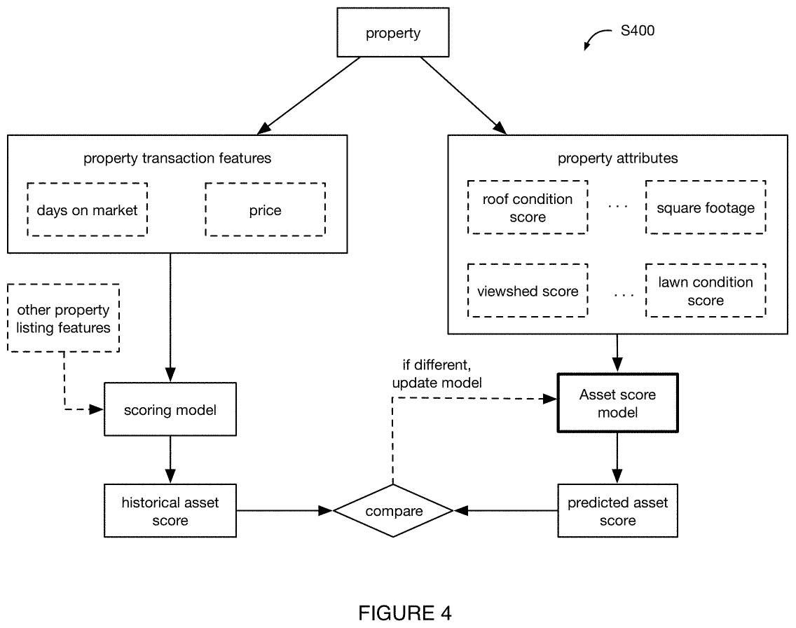

In a first variant, S400 includes training the asset score model to predict the historical asset score based on the respective property attributes for each of the training properties within the property set (e.g., example shown in FIG. 2 and FIG. 4).

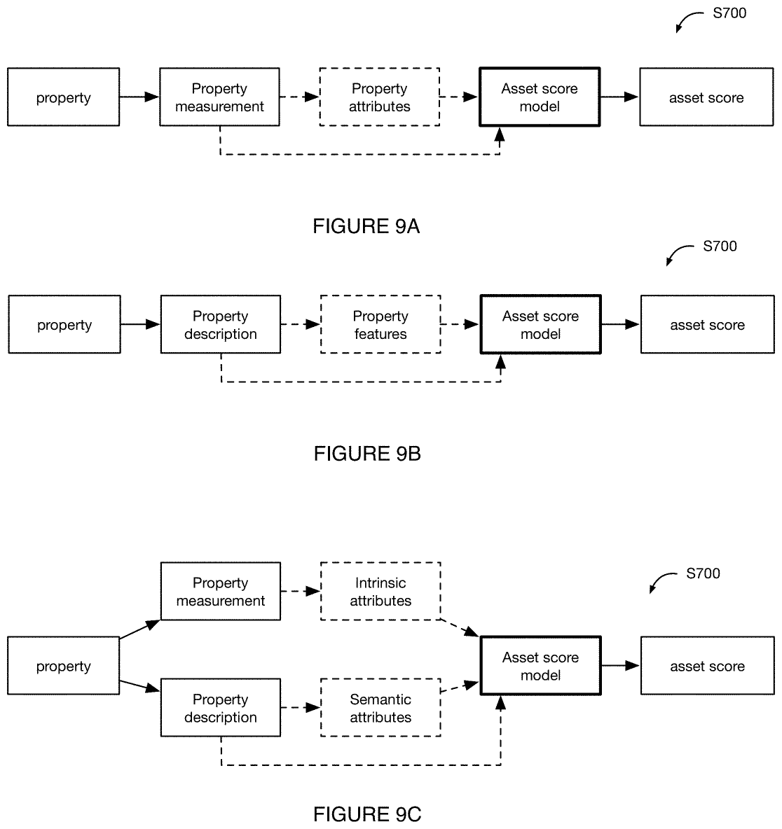

In a first embodiment, the property attributes include property attributes extracted from property measurements (e.g., imagery) (e.g., example shown in FIG. 9A) and/or intrinsic attributes. In an example, the property attributes can include condition attributes (e.g., roof condition, pool condition, yard debris, etc.). In a second example, the property attributes can include risk attributes (e.g., hazard scores). In a third example, the property attributes can include typicality attributes (e.g., typicality scores). In a fourth example, the property attributes can include structural attributes (e.g., building height, roof complexity, etc.). In a fifth example, the property attributes can include a combination of the above. In an illustrative example, the asset score model is trained to predict a historical liquidity score for the training property given property attributes (e.g., property condition attributes) extracted from an aerial image of the training property (e.g., from approximately the same timeframe as the training property list or sale). In a first specific example, the asset score model predicts the historical asset score based only on condition attributes. In a second specific example, the model predicts the asset score based on non-record attributes (e.g., because record attributes are inherently captured by the model/training data set). However, the asset score model can otherwise determine the historical asset score based on the property attributes.

In a second embodiment, the property attributes include a set of semantic attributes extracted from property descriptions (e.g., examples shown in FIG. 9B and FIG. 9C). In an illustrative example, the set of semantic attributes can be arranged into a semantic feature vector, wherein each vector position represents the value for a predetermined semantic feature (e.g., position 0 is “interior quality”, position 1 is “pool present”, position 2 is “move in ready”, etc.).

In a third embodiment, the property attributes include a combination of the above.

In a second variant, S400 includes training the asset score model to predict the historical asset score based on the respective property information for each of the training properties within the property set (e.g., examples shown in FIG. 9A and FIG. 9B).

In a first embodiment, the asset score model is trained to predict the historical asset score based on one or more property measurements for the training property (e.g., example shown in FIG. 9A). The property measurements can be full-frame measurements, be measurement segments (e.g., isolated to the region depicting the property), and/or be any other suitable measurement. In an illustrative example, the asset score model is trained to predict the historical liquidity score (e.g., directly) for the training property given an aerial image of the training property (e.g., from approximately the same timeframe as the training property list or sale).

In a second embodiment, the asset score model is trained to predict the historical asset score based on one or more property descriptions for the training property (e.g., example shown in FIG. 9B). In this embodiment, the asset score model can be an NLP model, a deep learning network, and/or be any other suitable model. In an illustrative example, the asset score model is trained to predict the historical liquidity score (e.g., directly) for the training property given the description for the training property (e.g., from approximately the same timeframe as the training property list or sale).

In a third variant, the asset score model is trained to predict the historic asset score based on the historic property information and/or property attributes (e.g., inherent attributes) and a list price (e.g., historic list price, a random list price, etc.) for the training property. In embodiments, this variant can predict the probability of property sale at the list price, predict the sale price based on the list price, predict the spread, predict the number of days on market, and/or predict any other suitable market attribute value.

In a fourth variant, the asset score model can be a lookup table that relates the historic asset score for each training property with the respective set of property attribute values.

However, the asset score model can be otherwise determined.

The method can optionally include determining a set of secondary market parameter (SMP) adjustments and/or SMP adjustment models (e.g., error models) based on the asset score, which functions to decrease the error on predicted secondary market parameters. Secondary market parameters can include property: valuation, rent, expenses, insurance, risk, vacancy, and/or any other suitable characteristic. In a first variant, the SMP adjustments for an SMP are iteratively evaluated until the SMP error (post-adjustment) falls below a threshold value. In a second variant, the SMP adjustment for an SMP is calculated based on the predicted SMP and the actual SMP. In an illustrative example, a property valuation for a property is predicted based on the property attributes for the property, and the error (e.g., difference between the predicted valuation and the sale price or actual valuation) can be assigned to the asset score for the property. In variants, the errors for all properties sharing the same asset score can be aggregated (e.g., averaged, etc.) and treated as the valuation adjustment value for the asset score. In a third variant, the SMP adjustments are learned (e.g., wherein the SMP adjustment model is trained on a loss between the SMP adjusted using a predicted adjustment and the actual SMP). However, the SMP adjustments and/or model for SMP adjustment determination can be otherwise determined.

However, the asset score model can be otherwise trained.

### 3.2 Predicting an Asset Score Using the Trained Asset Score Model

Predicting an asset score using the trained asset score model S20 can include: determining a test property S500, determining property information for a test property S600, and determining an asset score for the test property S700; example shown in FIG. 1. However, S20 can be otherwise performed. S20 can function to determine an asset score (e.g., a liquidity score) for the property before the property has been transacted (e.g., sold).

S20 can be performed: in response to a request identifying the property of interest, before receiving a request, when a property is listed, and/or at another suitable time. S20 is preferably performed by the processing system 400, but can alternatively be performed by a separate system.

Determining a test property S500 functions to determine a property of interest for asset score determination. The test property can be a pre-sale property (e.g., pre-listing, currently listed, etc.), non-transacted property (e.g., not transacted within the timeframe used to train the model, properties without transaction data, properties transacted outside of a predetermined timeframe, etc.), but can alternatively be post-sale, be a previously transacted property, and/or be any other suitable property. The asset score is preferably being determined for a hypothetical sale of the test property, but can alternatively be determined for an actual sale of the test property. The test property can be: identified in a request (e.g., the request includes a property identifier for the test property); be part of a batch of test properties (e.g., all properties listed within a predetermined timeframe, all properties depicted in a measurement, etc.); be randomly determined; and/or be otherwise determined.

Determining the property information for the test property S600 functions to determine the underlying property information for asset score determination. S600 can be performed: when new raw data (e.g., remote imagery) for the property is received by the system, periodically, responsive to a request identifying a property, responsive to test property determination, and/or at any other time. S600 can be performed for one or more test properties. The property information (e.g., measurements, descriptions, attributes, etc.) is preferably the same information as that used to train the model in S400, but can alternatively be different information. Property information for the test property can be determined in the same way as S200, and/or otherwise determined.

In a first variant, S600 includes retrieving property measurements (e.g., based on the test property identifier), and optionally determining property attributes based on the property measurements (e.g., using one or more attribute models). In an illustrative example, attributes can be extracted from an image (e.g., aerial image) of the test property. In a second variant, S600 includes retrieving property descriptions (e.g., based on the test property identifier), and optionally determining property attributes (e.g., semantic features) based on the property descriptions (e.g., using one or more attribute models).

However, the property attributes for a test property can be otherwise determined.

The method can optionally determining an asset score model. In a first variant, this includes selecting the asset score model. The asset score model is preferably selected based on the test property's attributes (e.g., common legal classes, location, record attribute values, etc.), but an alternatively be otherwise selected. In variants, an asset score model trained on properties with the same attribute values (e.g., geographic location number of bedrooms, etc.), timeframe (e.g., relative, absolute, etc.), market conditions (e.g., bull market, bear market, etc.), buyer population, and/or other model inputs can be selected. However, the asset score model can be randomly selected, be a default model, and/or be otherwise determined. In a second variant, determining the asset score model includes determining comparable properties for the test property, aggregating the comparable properties into a training property set, and training an asset score model based on the comparable properties' property information and market attribute data (e.g., performing S10 using the comparable properties). However, the asset score model can be otherwise determined.

Determining an asset score for the test property S700 functions to determine a pre-transaction asset score for the test property. S700 can optionally determine an error or uncertainty for the asset score. S700 can be performed once, periodically (e.g., daily, weekly, monthly, yearly, etc.), at random times, when requested, before property sale, and/or at any other time. S700 is preferably performed by the asset prediction model, but can alternatively be performed by another suitable entity. The asset score is preferably determined using the trained asset score model, but alternatively be retrieved from a database, and/or otherwise determined. The asset score can be determined based on: property attributes (e.g., property attribute values), property information (e.g., property measurements, property descriptions, etc.), market attributes (e.g., hypothetical list price, historic transaction information, list date, vacancies, supply, demand, etc.), and/or any other suitable set of inputs.

In a first variant, S700 includes predicting a (pre-transaction) asset score for the test property using the trained asset score model based on the test property's property attributes (e.g., examples shown in FIG. 9A and FIG. 9B).

In a second variant, S700 includes predicting a (pre-transaction) asset score for the test property using the trained asset score model based on the test property's property information (e.g., measurements and/or description) (e.g., examples shown in FIG. 9A and FIG. 9B).

In a third variant, S700 includes looking up the asset score associated with the test property's combination of property attribute values.

However, S700 can be otherwise performed.

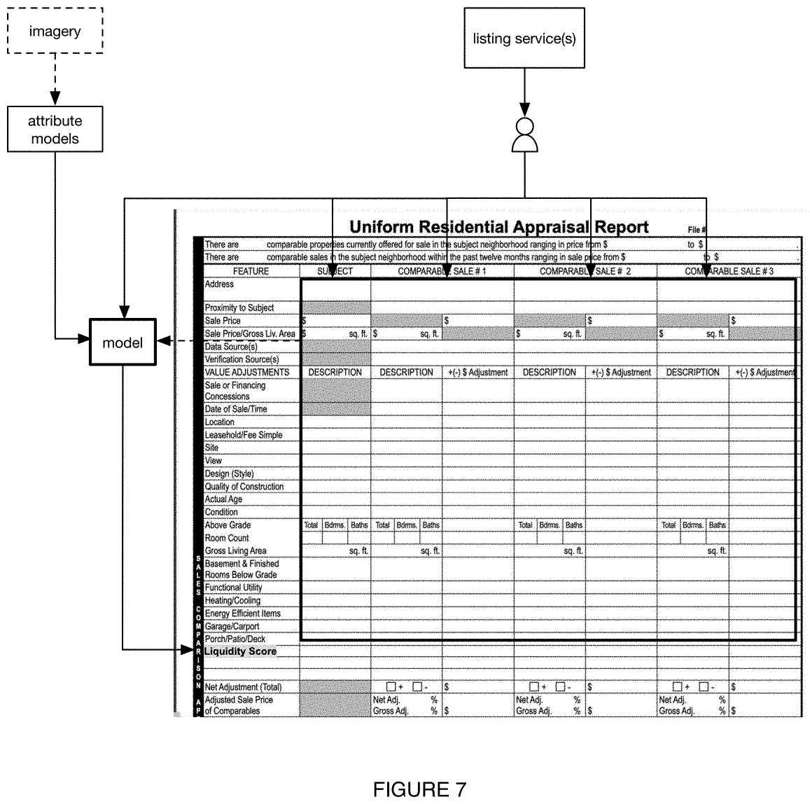

The method can optionally include providing the predicted asset score to an endpoint (e.g., through an interface). The endpoint can be: an endpoint on a network, a customer endpoint, a user endpoint, an automated valuation model system, a real estate listing service (e.g., Redfin™, MLS™, etc.), a real estate appraisal service, a real estate valuation provider, an insurance system, and/or any other suitable endpoint. The interface can be: a mobile application, a web application, a desktop application, an API, a database, and/or any other suitable interface executing on a user device, gateway, and/or any other computing system. For example, a real estate appraisal service can display the predicted asset score in the property appraisal evaluation form; example shown in FIG. 7.

However, the predicted asset score for the test property can be otherwise determined and/or used.

The method can optionally include calculating an accuracy score for the trained model based on the sale information for the property. For example, an actual asset score can be calculated for the test property (e.g., in a similar manner to that disclosed in S300), wherein the trained model's accuracy can be calculated based on the actual asset score and the predicted asset score (e.g., from S700). In variants, the trained model can be deprecated or retrained (e.g., based on the actual asset score for the test property) when the accuracy (e.g., for each test property instance or in aggregate) falls below a predetermined threshold. However, the accuracy score can be otherwise determined and/or used.

The method can optionally include using the asset score. The asset score is preferably used after it is determined (e.g., in S700), but can be used at any other time. The asset score can be used by a third party, by the system, and/or by any other suitable component or entity.

In a first variant, using the asset score includes determining a secondary market parameter (SMP) using the asset score for the test property. This is preferably performed using the secondary market parameter model (SMP model) and/or the SMP adjustment, but can alternatively be performed using any other suitable set of components. The determined SMP is preferably a pre-transaction SMP, but can alternatively be a post-transaction SMP.

In a first embodiment, the SMP model predicts the SMP based on the asset score determined in S700. In an example, the asset score can be used in real estate valuation/appraisal (e.g., use asset score as an input to an automated valuation model, which can incorporate additional types of distress discount; use asset score to detect error in property evaluation models; use asset score to determine automated valuation model accuracy, use asset score as a supplement to a property-level valuation report; etc.). Automated valuation models typically overestimate real estate valuation as a result of not taking liquidity into account, and consequently overestimate the discount associated with an illiquid property. Using the asset score as an input to an automated valuation model can determine a more accurate valuation.

In a second embodiment, the SMP model predicts the SMP (e.g., independent of the asset score determined in S700) based on information for the test property, an SMP adjustment is determined based on the asset score value for the test property, and the SMP is adjusted using the SMP adjustment to obtain a final SMP for the test property, wherein the final SMP is more accurate than the unadjusted SMP. In an illustrative example, a specific property's valuation output by an AVM can be modified by the property's asset score (e.g., apply a discount if the asset score is low, apply a premium is the asset score is high, etc.).

In a second variant, using the asset score includes evaluating the effect of a property change based on the asset score. This can be particularly useful for real estate management. In examples, this can include evaluating whether the liquidity score changes when a property change is made (e.g., a renovation, a repair, etc.), evaluating the valence of the liquidity score change due to the property change (e.g., whether the liquidity increases or decreases), determining which property change to make to adjust the liquidity score a predetermined direction or amount, and/or otherwise evaluating the property change against the liquidity score. This can include: determining a first asset score for a first set of test property attribute values (e.g., extracted from current property information), determining a second asset score for a second set of test property attribute values (e.g., hypothetical property attribute values, determined based on the evaluated property change), and comparing the first and second attribute scores. In a second example, the asset score can be used in real estate property management. In an illustrative example, the asset score can be used to identify potential areas of repairs/renovation by being aware of what aspects of the property significantly contribute to the asset score while getting the property ready for listing, such as by introspecting the model and/or determining attributes with high contributions to the asset score (e.g., using explainability metrics, such as SHAP values, using feature selection methodologies, etc.), and targeting those attributes for renovation. In a second illustrative example, optimal selling periods can be determined based on when training properties had highest asset score.

In a third variant, the asset score can be used as a filter. For example, the asset score can be used as a filter in real estate property investing (e.g., single family residential/institutional investors can fine-tune buy boxes, acquisition targets, and/or rental prices).

In a fourth variant, the asset score can be used to compare different properties. For example, the liquidity scores for different properties (e.g., neighboring properties) can be compared to determine the property similarities and/or differences. In another example, the liquidity scores for different properties sharing an attribute (e.g., within the same neighborhood) can be aggregated (e.g., averaged, etc.), which can enable a comparison between different property populations (e.g., different neighborhoods). In an illustrative example, this can determine the relative liquidity of different neighborhoods.

In a fifth variant, the asset score can be used in real estate and loan trading (e.g., non-performing loan traders benefitting from more informed loan purchases).

In a sixth variant, the asset score can be used by real estate mortgage lenders (e.g., pricing-in the asset score during underwriting).

However the asset score can be otherwise used.

The method can optionally include determining interpretability and/or explainability of the trained model, wherein the identified attributes (and/or values thereof) can be provided to a user, used to identify errors in the data, used to identify ways of improving the model, and/or otherwise used. Interpretability and/or explainability methods can include: local interpretable model-agnostic explanations (LIME), Shapley Additive explanations (SHAP), Ancors, DeepLift, Layer-Wise Relevance Propagation, contrastive explanations method (CEM), counterfactual explanation, Protodash, Permutation importance (PIMP), L2X, partial dependence plots (PDPs), individual conditional expectation (ICE) plots, accumulated local effect (ALE) plots, Local Interpretable Visual Explanations (LIVE), breakDown, ProfWeight, Supersparse Linear Integer Models (SLIM), generalized additive models with pairwise interactions (GA2Ms), Boolean Rule Column Generation, Generalized Linear Rule Models, Teaching Explanations for Decisions (TED), and/or any other suitable method and/or approach.

All or a portion of the models discussed above can be debiased (e.g., to protect disadvantaged demographic segments against social bias, to ensure fair allocation of resources, etc.), such as by adjusting the training data, adjusting the model itself, adjusting the training methods, and/or otherwise debiased. Methods used to debias the training data and/or model can include: disparate impact testing, data pre-processing techniques (e.g., suppression, massaging the dataset, apply different weights to instances of the dataset), adversarial debiasing, Reject Option based Classification (ROC), Discrimination-Aware Ensemble (DAE), temporal modelling, continuous measurement, converging to an optimal fair allocation, feedback loops, strategic manipulation, regulating conditional probability distribution of disadvantaged sensitive attribute values, decreasing the probability of the favored sensitive attribute values, training a different model for every sensitive attribute value, and/or any other suitable method and/or approach.

Different subsystems and/or modules discussed above can be operated and controlled by the same or different entities. In the latter variants, different subsystems can communicate via: APIs (e.g., using API requests and responses, API keys, etc.), requests, and/or other communication channels.

Different processes and/or elements discussed above can be performed and controlled by the same or different entities. In the latter variants, different subsystems can communicate via: APIs (e.g., using API requests and responses, API keys, etc.), requests, and/or other communication channels.

Alternative embodiments implement the above methods and/or processing modules in non-transitory computer-readable media, storing computer-readable instructions that, when executed by a processing system, cause the processing system to perform the method(s) discussed herein. The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUs, TPUS, microprocessors, or ASICs, but the instructions can alternatively or additionally be executed by any suitable dedicated hardware device.

Embodiments of the system and/or method can include every combination and permutation of the various elements discussed above, and/or omit one or more of the discussed elements, wherein one or more instances of the method and/or processes described herein can be performed asynchronously (e.g., sequentially), concurrently (e.g., in parallel), or in any other suitable order by and/or using one or more instances of the systems, elements, and/or entities described herein. Components and/or processes of the following system and/or method can be used with, in addition to, in lieu of, or otherwise integrated with all or a portion of the systems and/or methods disclosed in the applications mentioned above, each of which are incorporated in their entirety by this reference.

As a person skilled in the art will recognize from the previous detailed description and from the figures and claims, modifications and changes can be made to the embodiments of the invention without departing from the scope of this invention defined in the following claims.

We claim:

1. A system comprising a processing system configured to:
determine a set of property information for a property of interest;
determine a set of property attributes based on the set of property information;
determine a model trained on a set of training property conversion scores calculated from historic property conversion information for each of a set of training properties; and
predict a property conversion score for the property of interest based on the set of property attributes using the model.

2. The system of claim 1, wherein the historic property conversion information comprises a conversion duration for the respective training property.

3. The system of claim 2, wherein the historic property conversion information comprises a valuation for the respective training property.

4. The system of claim 3, wherein the training property conversion score for each training property is calculated from a percentile for the respective conversion duration and a percentile for the respective valuation.

5. The system of claim 1, wherein the set of property information comprises a set of property measurements, wherein the set of property attributes comprises a property condition attribute extracted from the set of property measurements.

6. The system of claim 5, wherein the property condition attribute is at least one of: a roof condition, a yard debris condition, or a paved surface condition.

7. The system of claim 5, wherein the set of property measurements comprise aerial imagery.

8. The system of claim 1, wherein the set of property attributes is determined from text descriptions of the property of interest using an NLP model.

9. The system of claim 1, further comprising predicting a market parameter for the property of interest based on the property conversion score.

10. The system of claim 1, wherein the market parameter comprises a valuation for the property of interest.

11. A method, comprising:
receiving a set of images of a property;
determining a set of property attributes from the set of images;
determine a model trained on historic property attributes and historic liquidity scores calculated from historic transaction data for each of a set of transacted properties; and
determining a pre-transaction liquidity score for the property based on the set of property attributes using the model.

12. The method of claim 11, wherein the set of images comprise an aerial image.

13. The method of claim 11, wherein the set of property attributes comprise intrinsic property attributes.

14. The method of claim 13, wherein the set of property attributes comprise condition attributes.

15. The method of claim 11, wherein the set of property attributes are determined using a set of attribute models, each configured to determine a property attribute from the set of images.

16. The method of claim 11, wherein the historic transaction data comprises days on market and sale price for each transacted property.

17. The method of claim 16, wherein the historic liquidity score is calculated from a days on market percentile and a sales price percentile for each transacted property.

18. The method of claim 11, wherein the set of transacted properties are located within a common geographic region and were transacted during a common transaction period.

19. The method of claim 11, further comprising determining a pre-transaction valuation adjustment based on the pre-transaction liquidity score.

20. The method of claim 11, further comprising predicting a pre-transaction valuation for the property based on the pre-transaction liquidity score.
